(19) United States
(12) Patent Application Publication
(10) Pub. No.: US 2003/0226037 A1
(43) Pub. Date: Dec. 4, 2003

(54) Authorization negotiation in multi-domain environment

(76) Inventor: Wai Kwan Mak, Laguna City (HK)

Correspondence Address: Pillsbury Winthrop LLP, Intellectual Property Group, Suite 2800, 725 South Figueroa Street, Los Angeles, CA, 90017-5406, US

(21) Appl. No.: 10/161,331

(22) Filed: May 31, 2002

(51) Int. Cl. H04L 9/00

(52) U.S. Cl. 713/201

(57) ABSTRACT

A multi-domain meta-authorization device generates at least one meta-authorization parameter if an authentication request for a first computing device is approved. The multi-domain meta-authorization device transmits the at least one meta-authorization parameter to a first authentication, authorization, and administration (AAA) device located on a first network. A mutually acceptable parameter generating device, located in the first AAA device, creates a plurality of mutually acceptable authorization parameters based on the input of the at least one meta-authorization parameter and operating characteristics of the first network. The mutually acceptable parameter generating device transmits the plurality of mutually acceptable authorization parameters to an access device to allow the first computing device to access the communications network through the first network.

### BACKGROUND

A. Technical Field

This invention relates generally to the field of authentication, authorization, and administration (AAA), and more specifically to a system, method, and apparatus, to generate meta-authorization parameters to allow a computing device to utilize a domain that is not its home domain.

B. Disclosure of the Art

Authentication, Authorization, and Accounting (AAA) (AAA Authorization Requirements, Internet Engineering Task Force, RFC 2906, August 2000; AAA Authorization Framework, Internet Engineering Task Force, RFC 2904, August 2000) refers to technologies that control access to a network based on the identity of computers. FIG. 1 illustrates a simple network where an access device utilizes an AAA device to control computing devices' access to a network application server according to the prior art.

AAA technologies are different from firewall technologies because AAA technologies control access based on the user's identity and not based on Internet Protocol addresses, like firewalls. AAA technologies require identification of the user and many different methods exist for accomplishing this task. The user may be queried for an ID and password, the system may use smart cards, or the system may use tokens. This identification of the user is referred to as authentication.

Once a user's identity is confirmed by an AAA device, the access device receives the user's privileges and access rights from a database within the AAA device and enforces the privileges and rights. This process is referred to as authorization.

Lastly, the user's actions and the resources the user consumes are recorded for accounting and auditing purposes. This process is referred to as accounting.

AAA is implemented in a system such as the one illustrated in FIG. 1 by utilizing an external AAA server to make the AAA decisions, while the access device, such as a virtual private network gateway, enforces the decisions. The access device requests that the AAA device authenticates the user. The AAA device authenticates the user and transmits the user's privileges and access rights to the access device. The access device enforces the user's privileges and access rights, and forwards all accounting records to the AAA device for analysis and storage.

AAA technologies, standards, and protocols support a single domain model where only one device controls access to network resources, such as an application server. In many areas, multiple domains share equipment, where one domain owns the enforcement equipment, i.e., the access device, and the other domain owns the authentication information, i.e., the AAA device. Sometimes, the two domains may not know each other in advance and intermediate domains act as a broker.

FIG. 2 illustrates the current handling of multi-domain AAA in a roaming Internet Service Provider (ISP) environment according to the prior art. In a roaming ISP environment, a user of a computing device attempts to access a communications network, e.g., an Internet, via a visiting ISP. The visiting ISP's access device, e.g., a dial-up server, requests authentication from the visiting ISP's AAA device. Because the user is visiting, the user's actual authentication data is located in a home ISP AAA device. Thus, the visiting ISP's AAA device forwards the user's authentication request to the home ISP's AAA device. The visiting ISP AAA device may follow an AAA protocol, such as RADIUS (Remote Authentication Dial In User Service, The Internet Society, RFC 2865, June 2000) or DIAMETER (DIAMETER FRAMEWORK, Calhoun, Zorn, Pan, Akhtar, draft-calhoun-diameter-framework-08.txt, IETF work in progress, June 2000), when transmitting information to the home ISP's AAA device. The home ISP's AAA device decides whether the user's ID and password are correct, i.e., whether the user has been authenticated.

If the home ISP AAA device decides the user is successfully authenticated, it sends an authentication approval and authorization information, e.g., a plurality of authorization parameters, back to the access device through the visiting ISP AAA device. Authorization parameters, in AAA terminology, includes, for example, access rights, privileges, the Internet Protocol (IP) address to use, a default route, idle timeout values, and other protocol parameters. In many cases, the home ISP may specify authorization parameters that are either unsupported or may cause problems in the visiting ISP's network. The visiting ISP AAA device may respond by discarding the home ISP's authorization parameters, and by inserting its own authorization parameters. The visiting ISP AAA device may send its own authorization parameters to the visiting ISP access device for the visiting ISP access device to enforce policies for the computing device to enter the communications network.

Parties in this environment have to accept that the domain that owns the equipment, i.e., the visiting ISP network, may override the authorization parameters of other parties, i.e., the home ISP network's parameters. In some cases, this occurrence may be marginally acceptable but in more security conscious environments, this occurrence is not acceptable.

### BRIEF DESCRIPTION OF THE DRAWINGS

FIG. 1 illustrates a simple network where an access device utilizes an AAA device to control computing devices' access to a network application server according to the prior art.

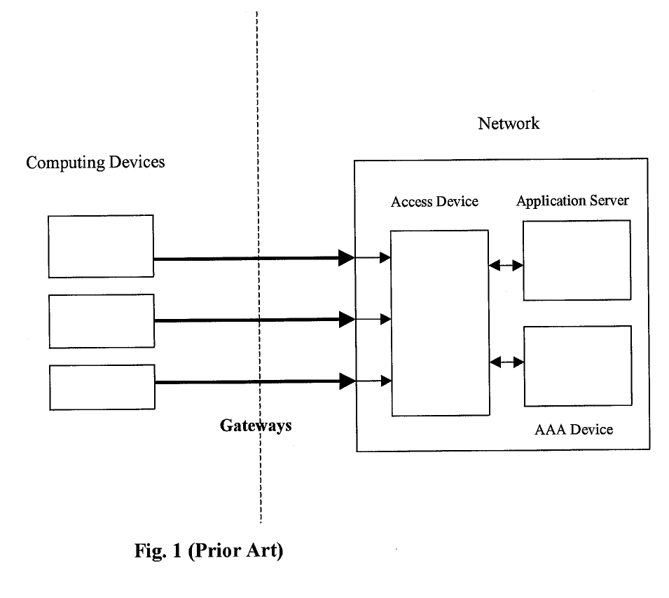

FIG. 2 illustrates the current handling of multi-domain AAA in a roaming Internet Service Provider environment according to the prior art;

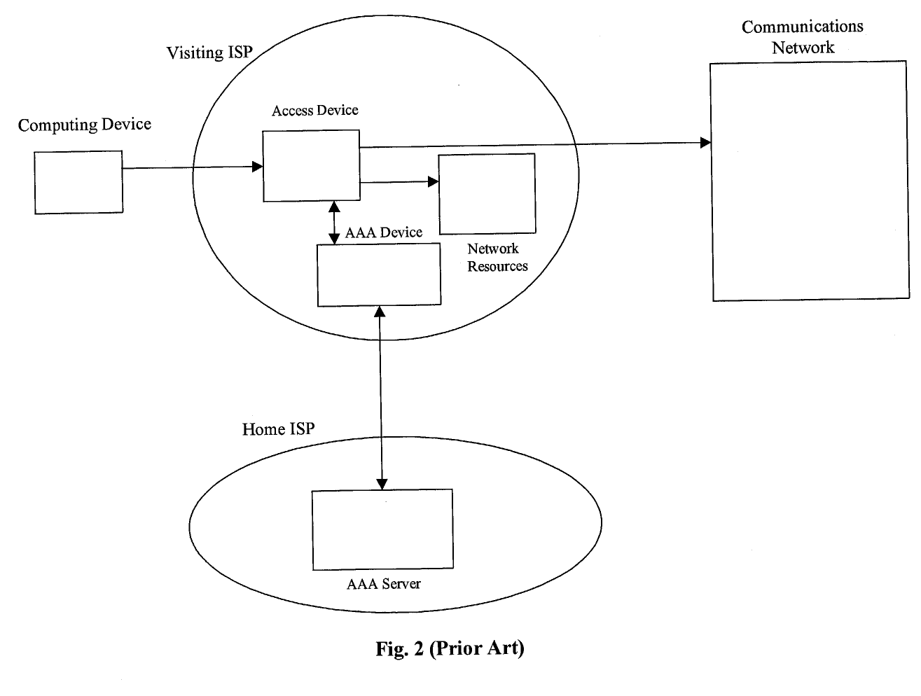

FIG. 3 illustrates a multi-domain administration authorization system according to an embodiment of the present invention;

FIG. 4 illustrates a meta-authorization parameter generating device according to an embodiment of the present invention;

FIG. 5 illustrates a mutually acceptable parameter generating device according to an embodiment of the present invention;

FIG. 6 illustrates a multi-domain meta-authorization system in an Internet Server Provider (ISP) roaming application according to an embodiment of the present invention;

FIG. 7 illustrates a multi-domain meta-authorization system in an application service provider (ASP) environment according to an embodiment of the present invention; and

FIG. 8 illustrates a flowchart of a meta-authorization parameter generating device according to an embodiment of the present invention.

### DETAILED DESCRIPTION

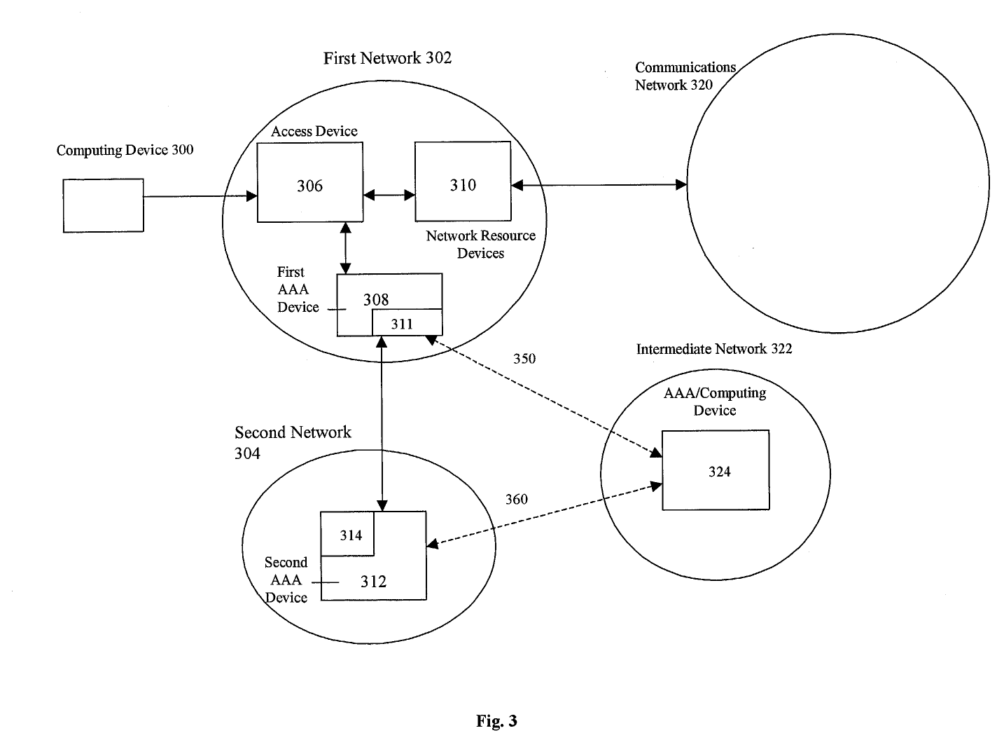

FIG. 3 illustrates a multi-domain meta-authorization system according to an embodiment of the present invention. The multi-domain meta-authorization system provides information to allow a computing device 300 to utilize authorization parameters that are acceptable to at least two domains: 1) the domain the computing device is accessing, i.e., the receiving domain; and 2) the domain the computing device normally utilizes, i.e., the computing device's home domain. Authorization parameters may be thought of network access configuration parameters. Authorization parameters may include access rights, privileges, e.g., which Internet Protocol (IP) (DARPA Internet Program Protocol Specification, Version 4, Internet Engineering Task Force, RFC 791, September 1981; Internet Protocol, Version 6 (Ipv6) Specification, Internet Engineering Task Force, RFC 2460, December 1998) the computing device is to use, the default route, and idle time out values. The authorization parameters that are acceptable to at least two domains may be referred to as mutually acceptable authorization parameters.

The multi-domain meta-authorization system may identify which authorization parameters may be changed or modified by the receiving domain and which authorization parameters may not be changed. For example, in some situations, certain authorization parameters may be mandatory for the home domain and not subject to change, and other authorization parameters may only be modified within a specific range. The receiving domain may generate mutually acceptable authorization parameters, i.e., to the home domain and receiving domain, that the computing device attempting to access the receiving domain may use.

In an embodiment of the present invention illustrated in FIG. 3, the computing device 300 may be attempting to enter a communications network 320, e.g, the Internet, through the receiving domain, i.e., the first network 302. The multi-domain meta-authorization system may include a computing device 300, a first network 302, and a second network 304. Illustratively, a domain may also be referred to as a network. The multi-domain meta-authorization system may also include at least one intermediate network 322.

The first network 302 may include an access device 306, an authentication, authorization, and administration (AAA) (AAA Authorization Requirements, Internet Engineering Task Force, RFC 2906, August 2000; AAA Authorization Framework, Internet Engineering Task Force, RFC 2904, August 2000) device 308, a mutually acceptable parameter generating device 311, and at least one network resource device 310.

In one embodiment of the present invention, the second network 304 may include a second AAA device 312. In addition, the second network 304 may include a second computing device (Not shown).

In an embodiment of the invention including an intermediate network 322, the intermediate network 322 may include an intermediate AAA device 324. In an alternative embodiment of the present invention, the intermediate network 322 may include an intermediate computing device 324. In other embodiments of the present invention, there might be multiple intermediate networks 322 with multiple intermediate AAA devices 324 or intermediate computing devices 324.

The computing device 300 may attempt to access a communications network 320 via the first network 302 by connecting to the access device 306. In one embodiment of the present invention, the communications network 320 may be an Internet. In an alternative embodiment of the present invention, the communications network 320 may be a private network. The computing device 300 may send an authentication request to verify that it may be able to access the communications network 320. For example, the computing device 300 may send a password and user-ID to the access device 306 to verify that it may be able to access the communications network 320.

In one embodiment of the present invention, the access device 306 may be a virtual private network (VPN) (Framework for IP based Virtual Private Networks, Internet Engineering Task Force, RFC 2764, February 2000) gateway. In an alternative embodiment of the present invention, the access device 306 may also be a dial-up server, a mobile Internet Protocol (IP) (IP Mobility Support of Ipv4, Internet Engineering Task Force, RFC 3220, January 2002) access device, or an application access device.

In an embodiment of the present invention, the access device 306 may relay the authentication request to the first AAA device 308. However, the actual authentication information resides in the second AAA device 312 in the second network 304. Therefore, the first AAA device 308 may forward the authentication request to the second AAA device 312. In one embodiment of the present invention, the first AAA device 308 may forward the authentication request to the second AAA device 312 according to an AAA protocol, such as RADIUS (Remote Authentication Dial In User Service, The Internet Society, RFC 2865, June 2000) or DIAMETER (DIAMETER FRAMEWORK, Calhoun, Zorn, Pan, Akhtar, draft-calhoun-diameter-framework-08.txt, IETF work in progress, June 2000). Illustratively, all AAA communications may be transmitted utilizing either the RADIUS or DIAMETER protocol.

If the second AAA device 312 determines that the user of the first computing device 300 is successfully authenticated, the second AAA device 312 may transmit an authentication acceptance back to the access device 306 through the first AAA device 308. In this embodiment of the present invention, the second AAA device 312 may transmit a plurality of authorization parameters to the first AAA device 308. In addition, a meta-authorization generating device 314 may create and transmit a meta-authorization parameter if the authentication request is approved, i.e., successfully authenticated. In another embodiment of the present invention, there may be multiple meta-authorization parameters created and transmitted if the authentication request is approved.

In the embodiment of the present invention illustrated in FIG. 3, the meta-authorization generating device 314 may be located in the second AAA device 312 on the second network 304. In an alternative embodiment of the present invention, the meta-authorization generating device 314 may be located in a second computing device (not shown) on the second network 304.

For example, the first AAA device 308 may receive the plurality of authorization parameters and the meta-authorization parameter. In one embodiment of the present invention, a mutually acceptable parameter generating device 311 may reside within the first AAA device 308. The mutually acceptable parameter generating device 311 may identify the meta-authorization parameter because the meta-authorization parameter has a special tag. The mutually acceptable parameter generating device 311 may utilize the meta-authorization parameter and the operating characteristics of the first network 302 to generate a plurality of mutually acceptable authorization parameters that are acceptable to both the first network 302 and the second network 304. The plurality of mutually acceptable authorization parameters may be based on the one meta-authorization parameter and operation requirements of the first network 302. In one embodiment of the present invention, the mutually acceptable parameter generating device 311 may transmit the plurality of mutually acceptable authorization parameters to the access device 306. The access device 306 may receive the plurality of mutually acceptable authorization parameters which allow the user of the computing device 300 to utilize the first network access device 306 to access the communications network 320 under the specified conditions. In one embodiment of the present invention, the access device 306 may override any previously received or utilized authorization parameters and instead utilizes the plurality of mutually acceptable authorization parameters.

In one embodiment of the present invention, the first AAA device 308 may receive the plurality of authorization parameters and the meta-authorization parameter. A mutually acceptable parameter generating device 311, within the first AAA device, may generate a plurality of mutually acceptable authorization parameters, and may transmit the plurality of mutually acceptable authorization parameters to the access device 306. The access device 306 may utilize the plurality of mutually acceptable authorization parameters to enforce the rights that are provided in the plurality of mutually acceptably authorization parameters. In an alternative embodiment of the present invention, the access device 306 may receive the plurality of authorization parameters and the at least one meta-authorization parameter. The mutually acceptable parameter generating device 311, located within the access device 306 for this embodiment, may generate a plurality of mutually acceptable authorization parameters, and may utilize the plurality of mutually acceptable authorization parameters to enforce the rights that were provided in the plurality of mutually acceptable authorization parameters.

In one embodiment of the present invention, if the first AAA device 308 receives the meta-authorization parameter and if the mutually acceptable parameter generating device 311 cannot create a plurality of mutually acceptable authorization parameters acceptable for both the first network 302 and the second network 304, the first AAA device 308 may send an authorization denied message to the access device 306. The access device 306 may transmit the authorization denied message to the user of the computing device 300. Alternatively, the first AAA device 308 may send an authorization denied message to the second AAA device 312, which may in turn transmit a new meta-authorization parameter to the first AAA device 308. In an alternative embodiment of the present invention, the second AAA device 312 may transmit more than one new meta-authorization parameters to the first AAA device 308 in response to the authorization denied message. In even another alternative embodiment of the present invention, the mutually acceptable parameter generating device 311 may send the authorization denied message directly to the access device 306.

In the embodiment of the present invention illustrated in FIG. 3, the authentication request may be forwarded to an intermediate AAA device 324 in an intermediate network 322. In other embodiments of the present invention, there may be multiple intermediate networks 322 and/or multiple intermediate AAA devices 324, but in the embodiment illustrated in FIG. 3, only one intermediate AAA device 324 and one intermediate network 322 are shown. As illustrated in FIG. 3, the intermediate AAA device 324 in the intermediate network 322 may be between the first network 302 and the second network 304. In this embodiment of the present invention, the intermediate AAA device 324 may receive the authentication request from the first AAA device 308, along path 350, and transfer the authentication request to the second AAA device 312, along path 360. The intermediate AAA device 324 may not modify the authentication request in any fashion. The second AAA device 312 may receive the authentication request and determine if the user of the first computing device 300 is authenticated. If the user is authenticated, the second AAA device may forward an authentication approval back to the computing device 300 through the same path the authentication request utilized (second AAA device 312 to intermediate AAA device 324 to first AAA device 308 to access device 306). In this embodiment of the present invention, the second AAA device 312 may also forward a plurality of authorization parameters to the first AAA device 308 through the intermediate AAA device 324.

In this embodiment of the present invention, if the user of the first computing device 300 is authenticated, as described earlier, the meta-authorization parameter generating device 314 may create a meta-authorization parameter and transmit the meta-authorization parameter to the intermediate AAA device 324. The intermediate AAA device 324 may receive the meta-authorization parameter and may transfer the meta-authorization parameter to the first AAA device 308. In such an embodiment of the invention, the intermediate AAA device 324 may not modify the meta-authorization parameter. In another embodiment of the present invention, a plurality of meta-authorization parameters may be generated and transmitted to the first AAA device 308 through the intermediate AAA device 324. As discussed previously, the first AAA device 308 may receive the plurality of authorization parameters and the one meta-authorization parameter. A mutually acceptable parameter generating device 311, within the first AAA device 308, may generate a plurality of mutually acceptable authorization parameters based on the meta-authorization parameter and first network operating requirements and may transmit the plurality of mutually acceptable authorization parameters to the access device 306.

In another embodiment of the present invention including the intermediate network 322, an intermediate computing device 324 may receive the authentication request from the first AAA device 308, and may transfer the authentication request to the second AAA device 312. Because the authentication request is not modified in any way, the intermediate network 322 may not need to include the intermediate AAA device 324. In such an embodiment of the present invention, the intermediate computing device 324 may receive the authentication approval from the second AAA device 312 and may transfer it to the access device 306 through the first AAA device 308. In this embodiment of the present invention, the intermediate computing device 324 may receive the plurality of authorization parameters and the meta-authorization parameter from the meta-authorization parameter generating device 314, and may transfer both the plurality of authorization parameters and the meta-authorization parameter to the first AAA device 308.

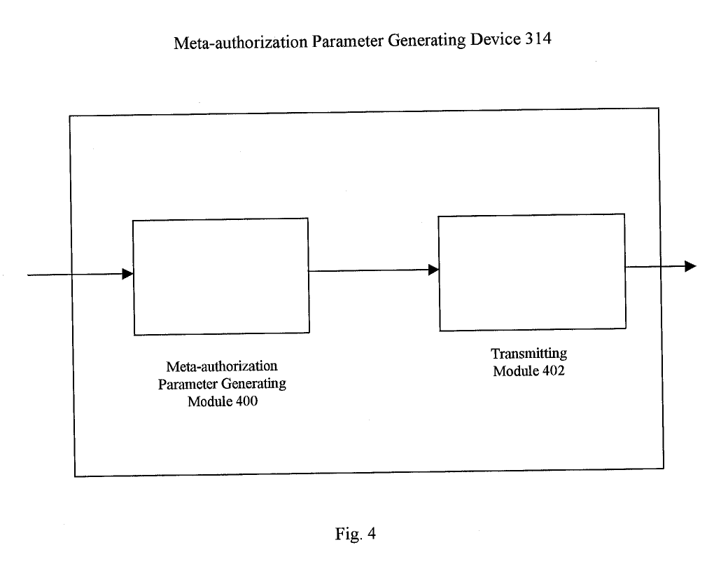

FIG. 4 illustrates a meta-authorization parameter generating device according to an embodiment of the present invention. The meta-authorization parameter generating device 314 may include a meta-authorization parameter generating module 400 and a transmitting module 402. If the authentication request generated by the first computing device is approved by the second AAA device 312 (see FIG. 3), i.e., the user of the first computing device 300 is authenticated and an authentication approval is generated, the meta-authorization parameter generation module 400 may create a meta-authorization parameter. In other embodiments of the present invention, the meta-authorization parameter generating module 400 may create more than one meta-authorization parameters. The meta-authorization parameter may identify which of a plurality of authorization parameters that the second network 304 may allow to be modified or deleted, and the meta-authorization parameter may also identify which of the plurality of the authorization parameters that the second network 304 may not allow to be modified or deleted. In another embodiment of the present invention, the meta-authorization parameter may also identify which of the plurality of authorization parameters may be added.

In one embodiment of the present invention, the transmitting module 402 may transmit the meta-authorization parameter to the first AAA device 308. In an alternative embodiment of the present invention, the transmitting module 402 may transmit the meta-authorization parameter to the intermediate AAA device 324. In another alternative embodiment of the present invention, the transmitting module 402 may transmit the meta-authorization parameter to the intermediate computing device 324 in the intermediate network 322.

In one embodiment of the present invention, the meta-authorization parameter generating module 400 and the transmitting module 402 may be located within the second AAA device 312 (see FIG. 3) in the second network 304. In an alternative embodiment of the present invention, the meta-authorization parameter generating module 400 and the transmitting module 402 may be located within a second computing device in the second network 304.

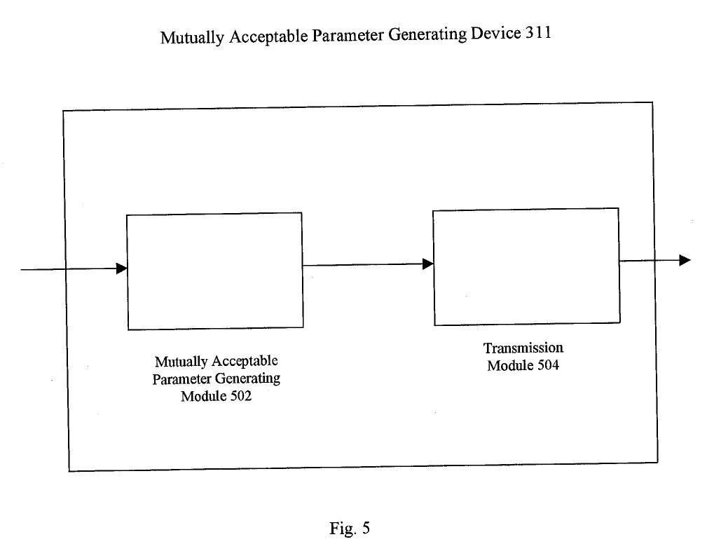

FIG. 5 illustrates a mutually acceptable parameter generating device according to an embodiment of the present invention. The mutually acceptable parameter generating device 311, which may be located inside the first AAA device 310, may include a mutually acceptable parameter generating module 502 and a transmission module 504. In one embodiment of the present invention, the first AAA device 308 (see FIG. 3) may receive the meta-authorization parameter and the plurality of authorization parameters from the second AAA device 312. Based upon the meta-authorization parameter and the operating characteristics of the first network 302, the mutually acceptable parameter generating device 311 may create a plurality of mutually acceptable authorization parameters. The transmission module 504 may transmit the plurality of mutually acceptable authorization parameters to the access device 306. In one embodiment of the present invention, the first AAA device 308 may receive the meta-authorization parameter and the plurality of authorization parameters from the intermediate AAA device 324 or the intermediate computing device 324.

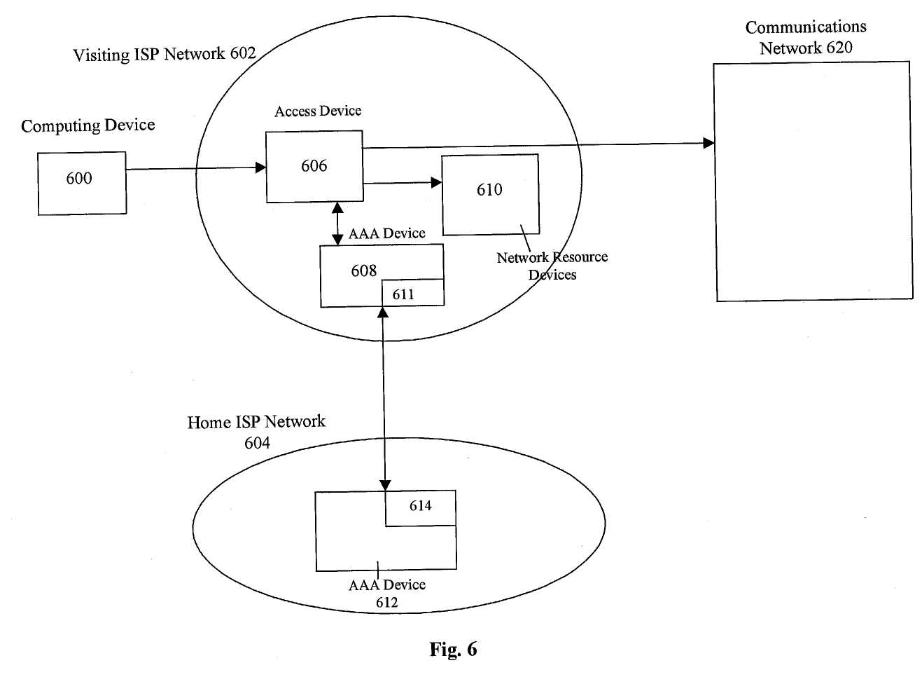

FIG. 6 illustrates a multi-domain meta-authorization system in an Internet Server Provider (ISP) roaming application according to an embodiment of the present invention. The ISP multi-domain meta-authorization system may include a first computing device 600 utilized by an end-user, a visiting ISP network 602, a communications network 620, and a home ISP network 604. The visiting ISP network 602 may include an access device 606, a plurality of network resource devices 610, a first authentication, authorization, and administration (AAA) device 608, and a mutually acceptable parameter generating device 611. The home ISP network 604 may include a home AAA device 612 and a meta-authorization parameter generating device 614.

In this embodiment of the present invention, the end-user of the computing device 600, who is at a location different that the one from where he or she normally logs in, attempts to login to the communications network 620, e.g., the Internet, by logging into the access device 606 of the visiting ISP network 602. The end-user of the computing device 600 may request to login to the Internet using the home ISP network's 604 authentication through the visiting ISP network 602 (and broker ISP networks if necessary). The end-user of the computing device 600 may utilize, for example, a user-ID and a password, to attempt login. In other words, the end-user of the computing device 600 is submitting an authentication request to the access device 606 on the visiting ISP network 602.

In one embodiment of the present invention, the access device 606 may forward the authentication request to the first AAA device 608. Because the end-user of the first computing device 600 may not normally attempt to access the Internet from the visiting ISP network 602, the first AAA device 608 may not contain authentication information for the end-user of the computing device 600. Thus, the first AAA device 608 may forward the authentication request to the home ISP AAA device 612 on the home ISP network 604, where the end-user of the computing device 600 may normally try to attempt to access the communications network 620.

In this embodiment of the invention, the home ISP AAA device 612 may receive the authentication request and may determine if the end-user of the computing device 600 is authenticated. If the end-user of the computing device 600 is authenticated, the home AAA device 612 may transmit an authentication approval back to the access device 606 through the first AAA device 608. The home ISP AAA device 612 may also transmit authorization parameters back to the access device 606 through the first AAA device 608. If the end-user of the computing device 600 is authenticated, then a meta-authorization parameter generating device 614 may transmit a meta-authorization parameter to the first AAA device 608. In other embodiments of the present invention, more than one meta-authorization parameter may be generated by the meta-authorization parameter generating device 614 and sent to the first AAA device 608. The meta-authorization parameter may indicate to the first AAA device 608 which of the authorization parameters previously sent by the home ISP AAA device 612 may be added, modified, inserted, or deleted.

In this embodiment of the present invention, the first AAA device 608 in the visiting ISP network 602 may receive the authorization parameters and the meta-authorization parameter from the home ISP AAA device 612. The mutually acceptable parameter generating device 611, within the visiting ISP AAA device 608, may recognize the meta-authorization parameter because a special tag has been inserted in the meta-authorization parameter. The mutually acceptable parameter generating device 611 may generate a plurality of mutually acceptable authorization parameters based upon the information contained in the meta-authorization parameter and based on operating requirements of the visiting ISP network 602. The mutually acceptable parameter generating device 611 may transmit the plurality of mutually acceptable authorization parameters to the access device 606 in the visiting ISP network 602. As long as the end-user of the computing device 600 utilizes the visiting ISP network 602 in accordance with the plurality of mutually acceptable authorization parameters, the access device 606 may allow the end-user of the computing device 600 to utilize the visiting ISP network 602 to access the communications network 620. Because of the meta-authorization parameter, the access device 606 may have authorization parameters that are acceptable to both the visiting ISP network 602 and the home ISP network 604.

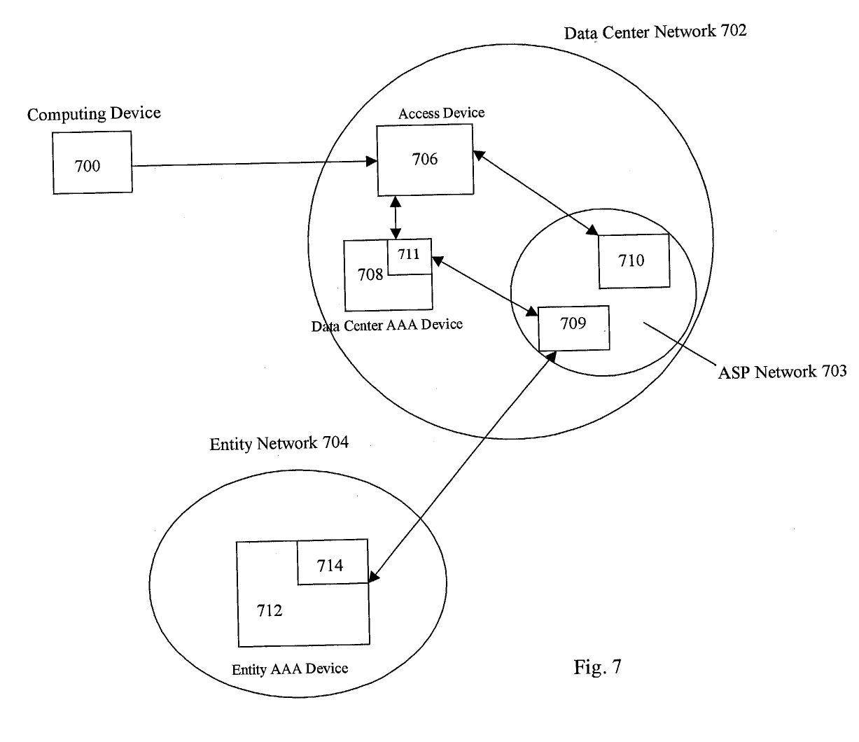

FIG. 7 illustrates a multi-domain meta-authorization system in an application service provider (ASP) environment according to an embodiment of the present invention. An ASP environment may be an environment where an entity utilizes a third party network, instead of the entity's network, to run specific software applications. In this embodiment of the present invention, the ASP environment 703, i.e., ASP network, may be located in a data center network 702. The multi-domain meta-authorization system in an ASP environment 703 may include an end user of a computing device 700, a data center network 702, an ASP network 703, and a home organization, i.e., entity, network 704. The data center network 702 may include an access device 706, a data center AAA device 708, and a mutually acceptable parameter generating device 711. The ASP network 703 may include a plurality of application servers 710 and an ASP AAA device 709. The home organization or entity network 704 may include an entity AAA device 712 and a meta-authorization parameter generating device 714.

The end user of the computing device 700 may submit an authentication request to the access device 706 in the data center network 702 in order to attempt to enter the ASP network 703 and to utilize the plurality of applications servers 710. The access device 706 may receive the authentication request and forward the authentication request to the data center AAA device 708. In this embodiment of the present invention, the data center AAA device 708 may not have contain the authentication information, so the data center AAA device 708 may transfer the authentication request to the ASP AAA device 709 in the ASP network 703. The ASP AAA device 709 may not contain the authentication information, so the ASP AAA device 709 may transfer the authentication request to the entity AAA device 712.

In this embodiment of the present invention, the entity AAA device 712 may determine if the end user of the computing device 700 is authenticated. If the end user of the computing device 700 is authenticated, the entity AAA device 712 may transmit an authentication approval and a plurality of authorization parameters to the access device 706 through the ASP AAA device 709 and the data center AAA device 708. In this embodiment of the present invention, a meta-authorization parameter generating device 714 may create a meta-authorization parameter and transmit the meta-authorization parameter to the ASP AAA device 709. In other embodiments of the invention, the meta-authorization parameter generating device 714 may create more than one meta-authorization parameter. The ASP AAA device 709 may receive and may transfer the at least one meta-authorization parameter to the data center AAA device 708. The ASP AAA device 709 may not modify the at least one meta-authorization parameter.

In this embodiment of the present invention, the data center AAA device 708 may receive the plurality of authorization parameters and the at least one meta-authorization parameter. The mutually acceptable parameter generating device 711 may recognize the meta-authorization parameter because of a tag placed in a field of the meta-authorization parameter. Based upon the at least one meta-authorization parameter and the data center network operating requirements, the mutually acceptable parameter generating device 711 may create a plurality of mutually acceptable authorization parameters that are acceptable to the entity network 704 and the data center network 702. Illustratively, the plurality of mutually acceptable authorization parameters may be transmitted to the access device 706. In this embodiment of the present invention, the access device 706 may allow the end user of the computing device 700 to access the plurality of application servers 710 in the ASP network 703 through the data center network 702 within the constraints identified in the plurality of the mutually acceptable authorization parameters.

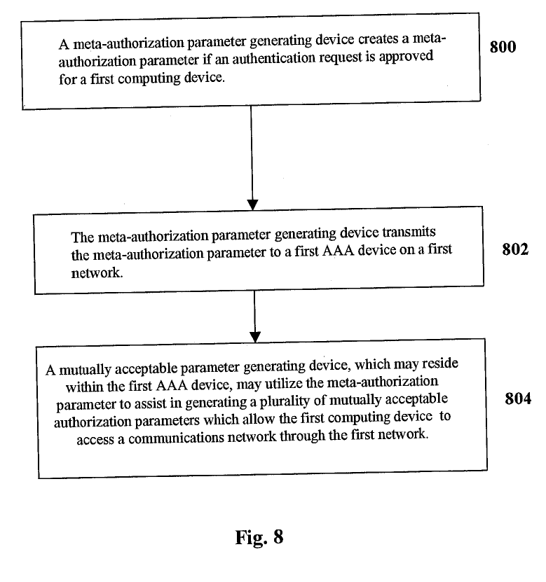

FIG. 8 illustrates a flowchart of a meta-authorization parameter generating device according to an embodiment of the present invention. A meta-authorization parameter generating device 400 (see FIG. 4) may create 800 a meta-authorization parameter if an authentication request is approved for a first computing device 300 (see FIG. 3). The meta-authorization parameter generating device 314 may transmit 802 the meta-authorization parameter to a first AAA device 308 on a first network 302. A mutually acceptable parameter generating device 311, which may reside within the first AAA device 308, may utilize the meta-authorization parameter to assist in generating 804 a plurality of mutually acceptable authorization parameters which allow the first computing device 300 to access a communications network 320 through the first network 302.

While the description above refers to particular embodiments of the present invention, it will be understood that many modifications may be made without departing from the spirit thereof The accompanying claims are intended to cover such modifications as would fall within the true scope and spirit of other embodiments of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are intended to be embraced therein.

What is claimed is:

1. A meta-authorization parameter generating device, comprising:
a meta-authorization parameter generating module to generate at least one meta-authorization parameter if an authentication request is approved; and
a transmitting module to send the at least one meta-authorization parameter to a requesting computing device.

2. The meta-authorization parameter generating device of claim 1, wherein the authentication request passes through an authentication, authorization, and administration (AAA) device in a first network.

3. The meta-authorization parameter generating device of claim 2, wherein the authentication request is further transmitted through at least one intermediate AAA device on at least one intermediate network.

4. The meta-authorization parameter generating device of claim 2, wherein the authentication request is further transmitted through at least one intermediate computing device on at least one intermediate network.

5. The meta-authorization parameter generating device of claim 1, wherein the meta-authorization parameter generating module and the transmitting module are located within a same physical device.

6. The meta-authorization parameter generating device of claim 5, wherein the physical device is an AAA device on a second network.

7. The meta-authorization parameter generating device of claim 5, wherein the physical device is a second computing device on a second network.

8. A multi-domain meta-authorization system, comprising:
a computing device to transmit an authentication request to enter a communications network;
an access device on a first network to receive the authentication request and to transmit the authentication request;
a first authentication, authorization, and administration (AAA) device on the first network to receive the authentication request from the access device and to relay the authentication request to a second network; and
a second AAA device on the second network to receive the authentication request, to authenticate the computing device, to send an authentication approval, and to transmit a plurality of authorization parameters;
a meta-authorization parameter generating device on the second network to generate at least one meta-authorization parameter if the computing device is authenticated, and to transmit the at least one meta-authorization parameter to the first AAA device on the first network wherein the first AAA device receives the plurality of authorization parameters and the at least one meta-authorization parameter; and
a mutually acceptable parameter generating device to create a plurality of mutually acceptable authorization parameters based on the at least one meta-authorization parameter and first network operating requirements, and to transfer the plurality of mutually acceptable authorization parameters to the access device to allow the computing device to enter the communications network through the first network.

9. The meta-authorization system of claim 8, wherein the communications network is an Internet.

10. The meta-authorization system of claim 8, wherein at least one intermediate AAA device on at least one intermediate network receives the authentication request from the first AAA device on the first network and relays the authentication request to the second AAA device on the second network.

11. The multi-domain meta-authorization system of claim 8, wherein at least one intermediate computing device on at least one intermediate network receives the authentication request from the first AAA device on the first network and relays the authentication request to the second AAA device on the second network.

12. The multi-domain meta-authorization system of claim 11, wherein the at least one intermediate computing device only transfers the at least one meta-authorization parameter.

13. The meta-authorization system of claim 8, wherein the first network is a roaming/visiting Internet Service Provider (ISP) for a user of the computing device, and the second network is a home ISP for the user of the computing device.

14. The meta-authorization system of claim 8, wherein the first network is an application service provider (ASP) for an entity, and the second network is a network for the entity.

15. A method of providing meta-authorization parameters for a first network and a second network, comprising:
creating, at a meta-authorization parameter generating device, at least one meta-authorization parameter if an authentication request is approved for a first computing device; and
transmitting the at least one meta-authorization parameter to a first authentication, authorization, and administration (AAA) device to allow a mutually acceptable parameter generating device to create a plurality of mutually acceptable authorization parameters, which allow the first computing device to access a communications network through the first network.

16. The method of claim 15, wherein creating the plurality of mutually acceptable authorization parameters includes at least one of adding, inserting, and deleting the plurality of authorization parameters.

17. The method of claim 15, wherein access to the communications network is provided through an access device on a first network.

18. The method of claim 17, wherein the first AAA device is located on the first network.

19. The method of claim 18, wherein a second AAA device is located on a second network.

20. The method of claim 19, wherein generating the at least one meta-authorization parameter, and transmitting the at least one meta-authorization parameter all occur in the second AAA device located on the second network.

21. The method of claim 19, wherein generating the at least one meta-authorization parameter, and transmitting the at least one meta-authorization parameter all occur in a second computing device located on the second network.

22. The method of claim 19, wherein the first network is a roaming/visiting Internet Service Provider (ISP), and the second network is the computing device's home ISP.

23. The method of claim 19, wherein at least one intermediate network is located between the first network and the second network, the at least one meta-authorization parameter is received from the second AAA device by at least one intermediate AAA device, and the at least one meta-authorization parameter is transmitted from the at least one intermediate AAA device to the first AAA device.

24. The method of claim 23, wherein the first network is a data center network, the first AAA device is a data center AAA device, the second network is an entity network, the second AAA device is an entity AAA device, the at least one intermediate network is at least one Application Service Provider (ASP) network, and the at least one intermediate AAA device is at least one ASP AAA device.

25. A program code storage device, comprising:
a machine-readable storage medium; and
machine-readable program code, stored on a machine-readable storage medium, the machine-readable program code having instructions to
generate at least one meta-authorization parameter if an authentication request is approved for a first computing device, and
transmit the at least one meta-authorization parameter to a first authentication, authorization, and administration (AAA) device to allow a mutually acceptable parameter generating device to create a plurality of mutually acceptable authorization parameters, which allow the first computing device to access a communications network through a first network.

26. The program code storage device of claim 25, wherein the instructions to generate the at least one meta-authorization parameter and the instructions to transmit the at least one meta-authorization parameter reside within a second AAA device on a second network.

27. The program code storage device of claim 25, wherein the instructions to generate the at least one meta-authorization parameter and the instructions to transmit the at least one meta-authorization parameter reside within a second computing device on a second network.

28. A mutually acceptable parameter generating device, comprising:
a mutually acceptable generating module to generate a plurality of mutually acceptable authorization parameters based on the at least one meta-authorization parameter received at a first authentication, authorization, and administration (AAA) device and operating characteristics of a first network; and
a transmission module to transmit the plurality of mutually acceptable authorization parameters to an access device to allow a user of a computing device to gain access to the first network.

29. The mutually acceptable parameter generating device of claim 28, wherein the mutually acceptable generating module and the transmission module are located in a first authentication, authorization, and administration (AAA) device.

30. A method to create mutually acceptable authorization parameters, comprising:
receiving, at a first authentication, authorization, and administration (AAA) device, at least one meta-authorization parameter;
creating, at a mutually acceptable parameter generating module, a plurality of mutually acceptable authorization parameters based on the at least one meta-authorization parameter and first network operating characteristics; and
transmitting the plurality of mutually acceptable authorization parameters to an access device to allow a computing device to gain access to a communications network through a first network.

31. The method of claim 30, wherein the access device is a dial-up device.

32. The method of claim 30, wherein the access device is a virtual private network (VPN) gateway.

33. A program code storage device, comprising:
a machine-readable storage medium; and
machine-readable program code, stored on a machine-readable storage medium, the machine-readable program code having instructions to
receive at least one meta-authorization parameter;
create, at a mutually acceptable parameter generating module, a plurality of mutually acceptable authorization parameters based on the at least one meta-authorization parameter and first network operating characteristics; and
transmit the plurality of mutually acceptable authorization parameters to an access device to allow a computing device to gain access to a communications network through a first network.

34. The program code storage device of claim 33, wherein a first authentication, authorization, and administration (AAA) device receives the at least one meta-authorization parameter.
